(19) United States
(12) Patent Application Publication
(10) Pub. No.: US 2014/0019565 A1
(43) Pub. Date: Jan. 16, 2014

(54) APPARATUS AND METHOD FOR SELECTING MULTIPLE FILES IN AN ELECTRONIC DEVICE

(71) Applicant: SAMSUNG ELECTRONICS CO., LTD., Suwon-si (KR)

(72) Inventors: Rajmohan MOHANAN, Bangalore (IN); Chetahan Tumkur NARAYAN, Bangalore (IN); Divya YADAV, Bangalore (IN); Girish Ashok JOSHI, Bangalore (IN); Jaganath KANAKKASSERY, Bangalore (IN)

(21) Appl. No.: 13/941,938

(22) Filed: Jul. 15, 2013

(30) Foreign Application Priority Data
Jul. 13, 2012 (IN) 2854/CHE/2012
Jul. 8, 2013 (KR) 10-2013-0079540

(51) Int. Cl. H04L 29/08

(52) U.S. Cl. CPC H04L 67/06
USPC 709/206; 709/219

(57) ABSTRACT

An apparatus and a method for selecting multiple files in an electronic device are provided. In the apparatus, a display unit displays data stored in a server device, and a processing unit sends information of the data stored in the server device to a common location of the server device when the data is selected, and downloads at least one data selected from the data stored in the common location to the electronic device.

### CROSS-REFERENCE TO RELATED APPLICATION(S)

This application claims the benefit under 35 U.S.C. §119(a) of an Indian Provisional Patent Application filed on Jul. 13, 2012 in the India Patent Office and assigned Serial No. 2854/CHE/2012, and a Korean patent application filed on Jul. 8, 2013 in the Korean Intellectual Property Office and assigned serial No. 10-2013-0079540, the entire disclosures of which are hereby incorporated by reference.

### TECHNICAL FIELD

The present disclosure relates to data selection. More particularly, the present disclosure relates to selecting multiple files in an electronic device.

### BACKGROUND

There is a vast amount of information that is being moved around on a file exchange basis in a communication network in enterprises, educational institutions, and so on. A lot of information is shared between the server and the clients. A user with Bluetooth® enabled devices (mobiles, laptops, tablets) frequently browses the server to select, transfer, and share data of interest. In a communication environment, this remote data transfer may consist of multiple files or folders can be browsed and downloaded a using File Transfer Protocol (FTP) profile using Bluetooth®.

Users spend a reasonable amount of time and effort in browsing and selecting data to be downloaded as current FTP profiles in Bluetooth® allows selection of a file or files only from the current open folder. To download data present at other folder locations, the user repeats the process of selecting multiple files and downloading repeatedly by returning to the parent folder. In an FTP profile, while browsing the remote file system, the user can obtain a file from remote location by a ‘get’ operation. During the process of the data downloading, the browsing operation is paused and the user can resume the browsing only after the completion or the cancelling of the ‘get’ operation. The user has to wait until the ‘get’ operation is completed, and then proceed with browsing for further data selection which consumes valuable time and effort of the user.

Due to above mentioned reasons, the existing system cannot select multiple data from multiple locations and move the selected data to one common location which improves data selection efficiency. As a result, a more efficient manner for performing the same would be desirable to improve the user experience.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and system to select data from multiple locations in a FTP profile through the client device using Bluetooth communication and the selected files are moved to a common location.

Another aspect of the present disclosure is to provide a method for the user to deselect some data in the common location before downloading the data from the common location.

Another aspect of the present disclosure is to provide a method for the user to check the size of the selected data in the common location before downloading the data from the common location.

Another aspect of the present disclosure is to provide a method for the user to delete the data in the common location.

In accordance with an aspect of the present disclosure, an apparatus for selecting multiple files in an electronic device is provided. The apparatus includes a display unit displays data stored in a server device, and a processing unit sends information of the data stored in the server device to a common location of the server device when the data is selected, and downloads at least one selected data from data stored in the common location to the electronic device.

In accordance with another aspect of the present disclosure, a method for selecting multiple files in an electronic device is provided. The method includes sending information of data stored in a server device to a common location of the server device when the data is selected, and downloading at least one selected data from data stored in the common location to the electronic device.

In accordance with another aspect of the present disclosure, computer readable medium including program instructions which when executed by a processor cause the processor to perform a method for selecting multiple files in an electronic device is provided. The method includes sending information of data stored in a server device to a common location of the server device when the data is selected, and downloading at least one selected data from data stored in the common location to the electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of a client server system according to various embodiments of the present disclosure.

FIG. 2 illustrates a block diagram of a communication device according to various embodiments of the present disclosure;

FIG. 3 illustrates a communication device displaying folders in a server according to various embodiments of the present disclosure;

FIG. 4 illustrates a communication device displaying files in a selected folder according to various embodiments of the present disclosure;

FIG. 5 illustrates a communication device displaying selected items in a pool according to various embodiments of the present disclosure;

FIG. 6 illustrates a block diagram of a computing environment according to various embodiments of the present disclosure; and

FIG. 7 illustrates a flowchart for a method of downloading at least one file in a communication device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The various embodiments herein achieve a method and system which enables user of client device to select multiple files from multiple folders and send the selected files to a pool to download in a FTP Bluetooth environment. The method provides a pool which holds and displays information related to the selected files and the selected folders along with the available free memory space in user's communication device. Here, the method copies the selected files or stores file path information for the selected files in the pool. The method enables user to deselect and prioritize files to download from the displayed list in the pool. The method thus enables common operations to be performed efficiently while allowing the user to perform operations like file browsing, file selection uninterruptedly without need to repeat the procedure for every file or folder selection.

The client device can be a mobile phone, a Personal Digital Assistant (PDA), a tablet, a laptop, a personal computer and the like.

Throughout the description the term client device and communication device is used interchangeably.

Throughput the description the term data and files is used interchangeably.

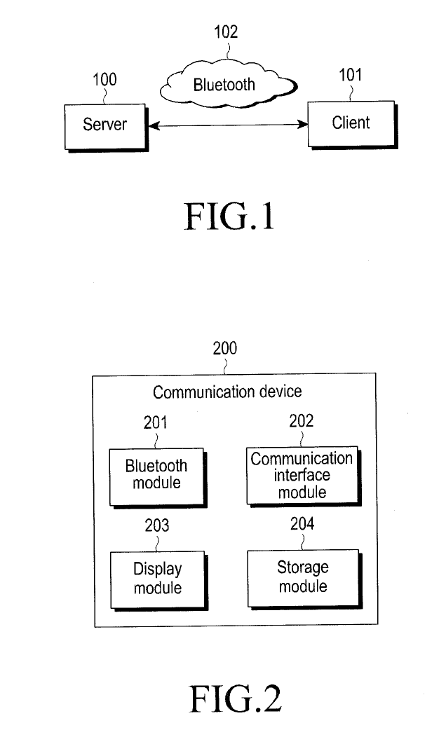

FIG. 1 illustrates a block diagram of the client-server system according to various embodiments of the present disclosure.

As depicted in FIG. 1, the server 100 and the client 101 communicate with each other via the Bluetooth® link 102 in the communication system.

FIG. 2 illustrates a block diagram of a communication device according to various embodiments of the present disclosure.

FIG. 2 depicts a communication device 200 with a Bluetooth module 201, a communication interface 202, a display module 203, and a storage module 204. These modules enable user to remotely share and transfer data such as multiple files and folders between peers using an FTP profile in a Bluetooth communication mode. In this embodiment, the server and the client device may be communicating in a File Transfer Protocol (FTP) mode using Bluetooth communication. A network with multiple communication devices along with server can form a peer-to-peer file sharing system. The Bluetooth module 201 facilitates communication between the communication device 200 and the server 100. The Bluetooth module comprises a transceiver to transmit and receive data between the communication device 200 and the server 100. The communication interface module 202 provides the communication link between the base station and the communication device 200. The display module 203 provides and displays the user interface to enable the user to select the files from the server 100. The storage module 204 allows storing of the selected files in the communication device 200. In an embodiment, the storage module 204 can be external memory card. In another embodiment, the storage module 204 can be the internal memory of the communication device 200.

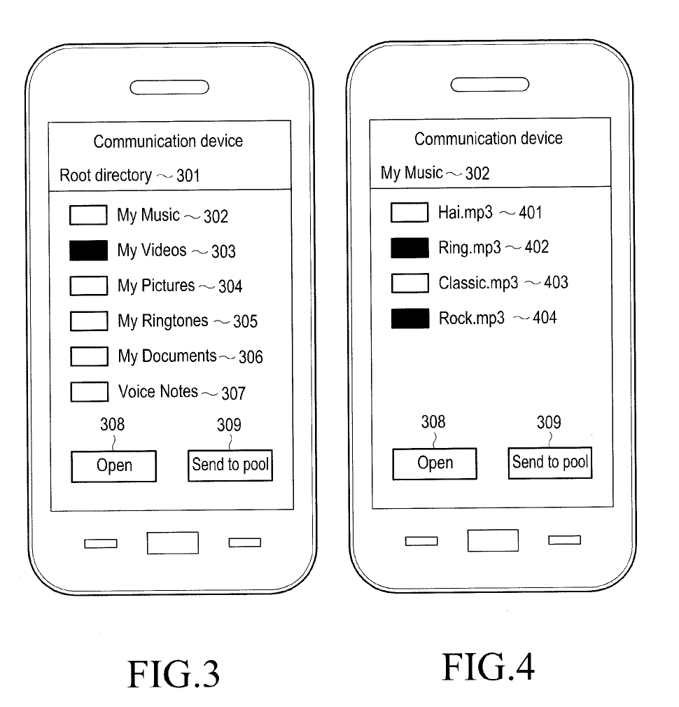

FIG. 3 illustrates a communication device displaying folders in a server root directory according to various embodiments of the present disclosure.

FIG. 3 shows communication device 200 used to browse files and folders in the peer device file system, such as the server 100 or the client 101. The display shows root directory 201 of a peer device which is being browsed by user. For example, user enters into an FTP file browser to select multiple files or folders. The FTP file browser displays contents of peer device file systems root directory having multiple folders such as “my music” 302, “my videos” 303, “my pictures” 304, “my ringtones” 305, “my documents” 306, and “voice notes” 307. In FIG. 3, the user selects the “my videos” 303 folder and clicks on the “send to pool” option 309 to download contents in the “my videos” 303 folder to the communication device 200. The user can select as many folders as desired and click on to “send to pool” option 309, which will store properties of the selected folders in a pool for later use. In an embodiment, the stored properties can be the path of the selected folder, folder information, and so forth. In an embodiment, the user can use “open” option 308 to view the details of files in the selected folder to browse further and select file(s) in the folder and clicks the “send to pool” option 309. In an embodiment, the “send to pool” option 309 stores the details of selected files in a common location or copies the selected files to the common location and provides a facility to the user to browse the file system without being interrupted by a download process which can be performed when the user desires.

FIG. 4 illustrates a communication device displaying files in a selected folder according to various embodiments of the present disclosure.

FIG. 4 shows the content of the “my music” folder 302 that is one of the folders in root directory 201 of peer device file system being browsed by the user. In an embodiment, the user selects “my music” folder 302 and clicks the “open” option 308 to select the files in the folder. The content of the “my music” folder 302 shows various song files such as “hai.mp3” 401, “ring.mp3” 402, “classic.mp3” 403, and “rock.mp3” 404. In an embodiment, user selects “ring.mp3” 402 and “rock.mp3” 404 songs and then clicks “send to pool” option 309, which sends all of the selected files to the common location. In an embodiment, if the user wishes to hear the song before sending the song to the pool, the user can click the “open” option 308 to hear the song and then send the song to the pool.

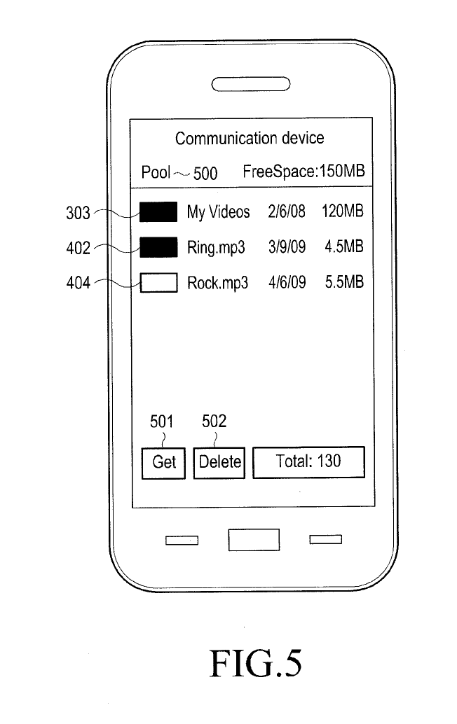

FIG. 5 illustrates a communication device displaying selected items in the pool according to various embodiments of the present disclosure.

FIG. 5 shows a pool 500 displaying all of the user selected files such as “ring.mp3” 402, “rock.mp3” 404 and the “my videos” folder 303 and serves as a common location where all items selected by the user are stored. Information such as a path of the selected file or folder, a file or a folder size, a file time stamp and so on can be stored, which enables the user to relook through the selected items and further decide if the user wants to download the selected items using the “get” 501 function.

In an embodiment, the user can deselect any file or folder in the pool before downloading. For example user deselects song file “rock.mp3” 404. By deselecting the files, the user avoids redundant downloads. In an embodiment, the user might have selected two similar files during an initial browsing and send the selected files to the pool 500. In the pool 500, the user can keep the better file and deselect the lesser file.

In an embodiment, the user can delete any file or folder in the pool 500. For example, the user can delete the “my videos” folder 303 in the pool using the “delete” option 502.

In an embodiment, the pool 500 can display the available free space in the local memory of the communication device so that user can have a comparison between the available free space in local memory and the size of data to be downloaded.

In an embodiment, the pool 500 displays the individual size of the selected files or folders and the collective size of the files or folders. If size of the data to be downloaded exceeds the available free space, the user can deselect items in the pool 500 as required.

In an embodiment, the user can reshuffle the selected files in the pool 500 to prioritize downloads and then can deselect the files exceeding the available free space.

In an embodiment, user can deselect any file or folder selected during browsing and sends to the pool 500. In the pool 500, the user can prioritize the files to be downloaded.

In an embodiment, the user can browse multiple files in a different memory location of the communication device and select the “send to pool” option 309. The user can also upload the selected files from the pool 500 on a user device to the server 100.

In an embodiment, the user can select multiple files in different memory locations of the communication device and select the “send to pool” option 309. From the pool 500, the user can attach multiple files in the pool 500 to an email and send to the message and attachments to a recipient.

In an embodiment, the Bluetooth FTP browsing function can be performed between a laptop and communication device, such as the communication device 200. In this case, the communication device displays multiple files stored in the laptop and transmits the details of at least one file when the “send to pool” option is selected. The communication device downloads the at least one file from the laptop when download of at the least one file among files stored in the pool 500 is requested by the user.

An e-mail function can be performed between a laptop and a communication device or a server and the communication device, such as the communication device 200. In this case, the communication device displays multiple files stored in the laptop or the server and transmits the details of at least one file to the pool 500 when the “send to pool” option 309 is selected after selecting the at least one file among the displayed multiple files by user. The communication device downloads an e-mail including the at least one file from the laptop or the server when the download of the at least one file in the pool 500 is requested by user.

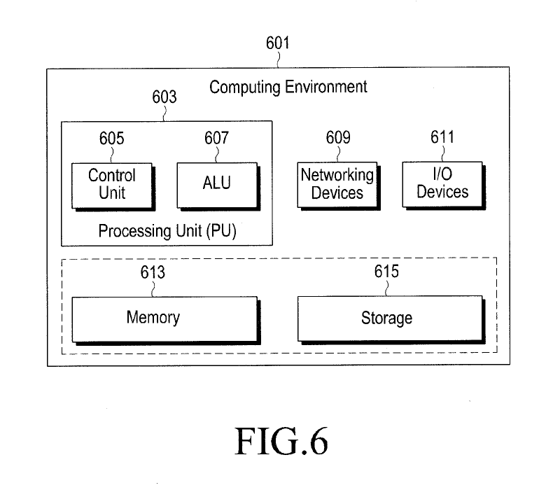

FIG. 6 illustrates a block diagram of a computing environment implementing an application according to various embodiments of the present disclosure.

As depicted in FIG. 6, the computing environment 601 comprises at least one processing unit 603 that is configured with a control unit 605 and an Arithmetic Logic Unit (ALU) 607, a memory 613, a storage unit 615, networking devices 609, and Input Output (I/O) devices 611. The processing unit 603 is responsible for processing the instructions of an algorithm for implementing a method or process by receiving commands from the control unit 605. Further, any logical and arithmetic operations involved in the execution of the instructions are computed with the help of the ALU 607.

In an embodiment, the processing unit 603 enables communication (e.g., wireless communication) with the server, receives the details for at least one file and/or folder included in a root directory from the server, and displays the name of the at least one file and/or folder. For example, the processing unit 603 can display the root directory as illustrated in FIG. 3. The processing unit 603 determines whether an “open” option of a folder among the displayed folder is selected by user. If the “open” option is selected, the processing unit 603 receives the details of the folder contents such as at least one file included in the folder, and displays the at least one name of the at least one file. For example, the processing unit 603 can display the “my music” folder 302 as illustrated in FIG. 4. The processing unit 603 determines whether an “open” option of at the least one file among the at least one file is selected by the user. If the “open” option is selected, the processing unit 603 executes the at least one file. For example, when the at least one file is a music file, the processing unit 603 can replay the music file.

If “open” option of a folder or a file is not selected, the processing unit 603 determines whether “send to pool” option of at least one folder or file among the at least one displayed folder or file is selected by the user. If the “send to pool” option is selected, the processing unit 603 transmits the details of the at least one folder or file to the pool, and determines whether the pool display is requested by the user. Alternatively, if pool option is selected, the processing unit 603 transmits the at least one folder or file to pool and determines whether the pool display is requested by user.

If the pool display is requested, the processing unit 603 displays the name and the details at least one folder or file stored in the pool. For example, the processing unit 603 displays the pool as illustrated in FIG. 5. The processing unit 603 determines whether a “get” option for at least one folder or file among the at least one folder or file is selected by user.

If the “get” option is selected, the processing unit 603 directly downloads the at least one folder or file or receives e-mail including the at least one folder or file. If “get” option is not selected, the processing unit 603 determines whether a “delete” option for at least one folder or file among the displayed folder or file is selected by user. If the delete option is selected, the processing unit 603 deletes the at least one folder or file.

If the “delete” option is not selected, the processing unit 603 determines whether the get option is selected.

The overall computing environment can be composed of multiple homogeneous and/or heterogeneous cores, multiple Central Processing Units (CPUs) of different kinds, microcontrollers, special media and other devices (e.g., graphics accelerators). The processing unit 603 is responsible for processing the instructions of the algorithm. The processing unit 603 receives commands from the control unit 605 in order to perform the processing. Further, any logical and arithmetic operations involved in the execution of the instructions are computed with the help of the ALU 607. Further, the process units, modules, and devices that perform the function of the processing unit 603 may be located on a single chip or over multiple chips.

The algorithm comprises instructions and codes required for the implementation are stored in either the memory unit 613 or the storage 615 or both. At the time of execution, the instructions may be fetched from the corresponding memory 613 and/or storage 615 and executed by the processing unit 603.

The networking devices 609 and the external I/O devices 611 may be connected to the computing environment 601 to support networking and user input/output.

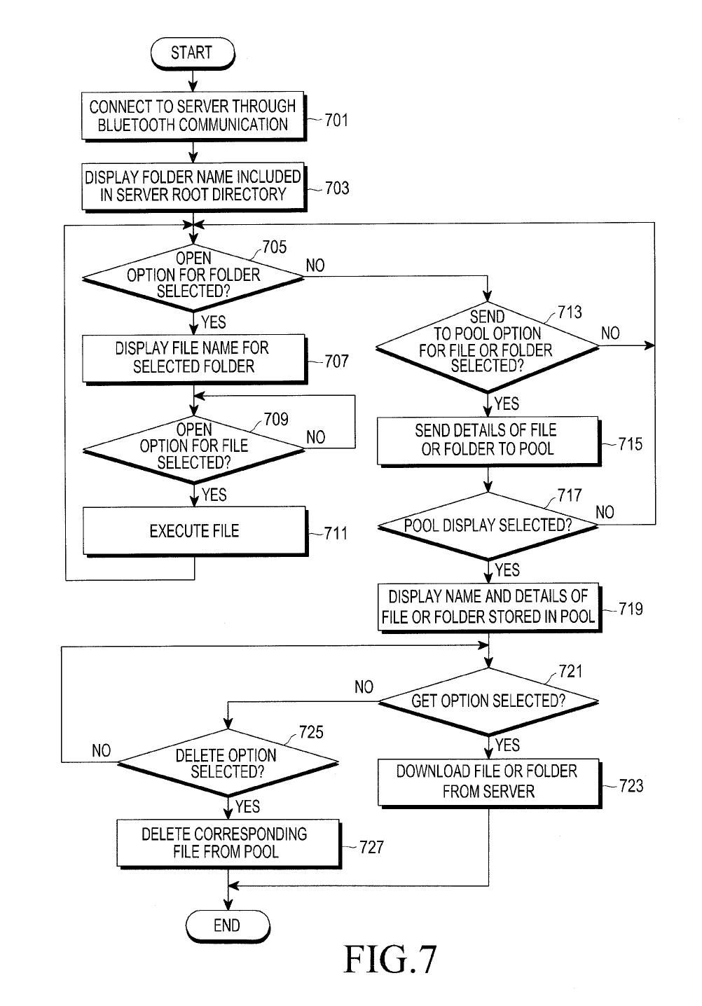

FIG. 7 illustrates a flowchart for a method downloading at least one file in a communication device according to various embodiments of the present disclosure.

Referring to FIG. 7, at operation 701, the communication device, such as the communication device 200, connects to the server via a Bluetooth communication link. At operation 703, the communication device receives the details for at least one folder included in a predetermined root directory from the server and displays name of the at least one folder. For example, the communication device can display a screen as illustrated in FIG. 3. At operation 705, the communication device determines whether an “open” option of a folder among the displayed folder is selected by the user. If the “open” option is selected, the communication device proceeds to operation 707 and otherwise, proceeds to operation 713.

At operation 707, the communication device receives the details for at least one file included in the folder and displays at least one name of the at least one file. For example, the communication device can display a screen as illustrated in FIG. 4. At operation 709, the communication device determines whether an “open” option of at least one file among the at least one file is selected by the user. If the “open” option is selected, the communication device proceeds to operation 711 and otherwise, proceeds to operation 705.

At operation 711, the communication device executes the at least one file. For example, when the at least one file is a music file, the communication device can replay the music file.

At operation 713, the communication device determines whether a “send to pool” option of at least one folder or file among the at least one displayed folder or file is selected by the user. If the “send to pool” option is selected, the communication device proceeds at operation 715 and otherwise, proceeds to operation 705. At operation 715, the communication device transmits the details of the at least one folder or file to the pool, and at operation 717, determines whether the pool display is requested by the user. Alternatively, the communication device 200 transmits the at least one folder or file to pool and determines whether the pool display is requested by the user. If the pool display is requested, the communication device proceeds to operation 719, and otherwise, proceeds to operation 705.

At operation 719, the communication device displays the name and the details at least one folder or file stored in the pool. For example, the communication device 200 displays a screen as illustrated in FIG. 5. At operation 721, the communication device 200 determines whether a “get” option for the at least one folder or file among the at least one folder or file is selected by the user. If the “get” option is selected, the communication device proceeds to operation 723, and otherwise, proceeds to operation 725.

At operation 723, the communication device directly downloads the at least one folder or file, or receives e-mail including the at least one folder or file. At operation 725, the communication device determines whether a “delete” option for at least one folder or file among the displayed folder or file is selected by the user. If the “delete” option is selected, the communication device 200 proceeds to operation 727, and otherwise, proceeds to operation 721. At operation 727, the communication device 200 deletes the at least one folder or file.

The various embodiments disclosed herein can be implemented through at least one software program running on at least one hardware device and performing network management functions to control the elements. The elements shown in FIGS. 1, 2 and 6 include blocks which can be at least one of a hardware device, or a combination of hardware device and software module.

The foregoing description of the specific various embodiments will so fully reveal the general nature of the various embodiments herein that others can, by applying current knowledge, readily modify and/or adapt for various applications such specific various embodiments without departing from the generic concept, and, therefore, such adaptations and modifications should and are intended to be comprehended within the meaning and range of equivalents of the disclosed various embodiments. It is to be understood that the phraseology or terminology employed herein is for the purpose of description and not of limitation. Therefore, while the various embodiments herein have been described in terms of preferred various embodiments, those skilled in the art will recognize that the various embodiments herein can be practiced with modification within the spirit and scope of the various embodiments as described herein.

For example, in the present invention, when a file is transmitted between a server and communication device, a server moves at least one file selected by user to pool, the disclosure is not restricted thereto. For example, when a file is transmitted between first communication device and second communication device, the first communication device moves at least one file selected by user to the pool, displays related information for the at least one file selected in the pool, and transmits the at least one file selected by user to the second communication device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for selecting multiple files in an electronic device, the method comprising:
sending information of data stored in a server device to a common location of the server device when the data is selected; and
downloading at least one data selected from the data stored in the common location to the electronic device.

2. The method of claim 1, wherein the information comprises at least one of a name, a path, a size, and a time stamp of the data.

3. The method of claim 1, wherein the downloading of the at least one data comprises:
displaying a capacity of a free memory area in the electronic device and a size information of the data stored in the common location; and
downloading the at least one data selected from the data stored in the common location.

4. The method of claim 3, wherein the displaying of the capacity comprises displaying size information corresponding to each of the data stored in the common location.

5. The method of claim 1, further comprising:
sending information of data to the common location when the data among at least one of data stored in the electronic device is selected by user; and
uploading at least one data selected from the data stored in the common location to the server.

6. The method of claim 1, wherein the downloading of the at least one data comprises receiving an e-mail including the at least one selected data.

7. An apparatus for selecting multiple files in an electronic device, the apparatus comprising:
a display unit to display data stored in a server device; and
a processing unit configured to send information of the data stored in the server device to a common location of the server device when the data is selected, and to download at least one data selected from data stored in the common location to the electronic device.

8. The apparatus of claim 7, wherein the information comprises at least one of a name, a path, a size, and a time stamp of the data.

9. The apparatus of claim 7, wherein the processing unit is further configured to display a capacity of free memory area in the electronic device and an entire capacity and information of the data stored in the common location, and to download the data selected from the data stored in the common location.

10. The apparatus of claim 9, wherein the processing unit is further configured to display the entire capacity, and a capacity and information corresponding to each of the data stored in the common location.

11. The apparatus of claim 7, wherein the processing unit is further configured to send information of data to the common location when the data among at least one of data stored in the electronic device is selected, and to upload at least one data selected from the data stored in the common location to the server.

12. The apparatus of claim 7, wherein the processor is configured to download an e-mail having the at least one selected data.

13. A non-transitory computer readable medium including program instructions which when executed by a processor cause the processor to perform a method for selecting multiple files in an electronic device, the method comprises:
sending information of data stored in a server device to a common location of the server device when the data is selected; and
downloading at least one data selected from data stored in the common location to the electronic device.

14. The method of claim 13, wherein the information comprises at least one of name, path, size, and time stamp of the data.

15. The method of claim 13, the downloading comprises displaying a capacity of free memory area in the electronic device, and an entire capacity and information of the data stored in the common location; and
downloading the data selected among the data stored in the common location.

16. The method of claim 15, the displaying comprises displaying the entire capacity, and a capacity and information corresponding to each of the data stored in the common location.

17. The method of claim 13, further comprising:
sending information of data to the common location when the data among at least one of data stored in the electronic device is selected; and
uploading the at least one data selected from data stored in the common location to the server.

18. The method of claim 13, wherein the downloading at least one selected data comprises receiving an e-mail including the at least one selected data.
